(19) United States
(12) Patent Application Publication
(10) Pub. No.: US 2024/0403839 A1
(43) Pub. Date: Dec. 5, 2024

(54) RETURN AUTOMATE

(71) Applicant: TBF COMPANY.DK APS, Helsinge (DK)

(72) Inventor: Lars GERLYKKE-DOHN, Helsinge (DK)

(73) Assignee: TBF COMPANY.DK APS, Helsinge (DK)

(21) Appl. No.: 18/700,459

(22) PCT Filed: Oct. 11, 2022
(86) PCT No.: PCT/EP2022/078266

§ 371 Date: Apr. 11, 2024

(30) Foreign Application Priority Data
Oct. 11, 2021 (DK) PA202170506
Oct. 11, 2022 (WO) PCT/EP2022/078266

(51) Int. Cl. G06Q 10/30; G06Q 20/20; G06Q 20/34

(52) U.S. Cl. CPC G06Q 10/30; G06Q 20/209; G06Q 20/34

(57) ABSTRACT

A recycling automate for receiving a spent item such as a bag or a piece of clothing, said automate comprising: an opening through which the item can be entered; a reader for registering an identification; a printer for producing a deposit receipt and/or a card reader for transfer of a token or payment of deposit for the spent item entered into the automate; a compartment for storing the spent items that has been entered through the opening, which compartment has an opening through which the automate can be emptied for the spent items.

### FIELD OF THE INVENTION

The present invention relates to the field of recycling, and specifically to the field of automates and bar-coded or chip-tagged items such as bags or clothing.

### BACKGROUND OF THE INVENTION

In today's world the buy-use-toss culture is a major problem for our planet and limited resources. Especially when it comes to everyday items that are used frequently and thus have a high consumption rate. Many of these products are made of plastic and/or fabric.

One obstacle for replacing the traditional plastic bags not being compostable or biodegradable is the cost of alternative bags. For this reason they do not constitute viable alternatives to the buy, use and discard as trash concept as for regular plastic or paper bags. Packaging bags for e.g. food products also typically are made from plastic posing a waste disposal problem if not recycled properly.

Bags made of fabric are sold in many shops and consumers can use and reuse such bags. However, often the bag is not at hand and it tends to be discarded as waste instead of being washed and reused the number of times that the bag actually can be used.

This is the same problem with clothing, often produced by the fast-fashion industry, where the fabric has a short life-span and the clothing are thus quickly thrown out by the buyer after a short period of use. Either because the fabric didn't hold well and got worn/damaged, or because the fabric is too dirty to bother cleaning.

Therefore, there is a need for an improved system for recycling of these items (for example bags and/or clothing).

This would not require the individual consumer to keep, hold and clean a bag and/or clothing for a prolonged period for reuse.

Also, there is a need for effective systems for recycling plastic bags used as packaging in a wide area of industries.

### SUMMARY OF THE INVENTION

In a first aspect of the invention, there is provided a recycling automate (100) for receiving a used item (110) such as a bag and/or a piece of clothing, said automate (100) comprising: a first opening (200) through which the item may be positioned inside the automate, a reader (210) for registering an item identification (215), a printer (220) for producing a deposit receipt and/or a card reader (230) for transfer of a token or payment of deposit for the used item placed inside the automate, a compartment (240) for receiving from the first opening (200) the used item (110) and/or storing said used item (110), a second opening (250) adapted to enable said automate to be emptied for used items (110).

In an embodiment there is provided a bag automate (100) for receiving a spent bag (110), said bag automate comprising: an opening (200) through which the bag can be entered; a reader (210) for registering a bag identification; a printer (220) for producing a deposit receipt and/or a card reader (230) for transfer of a token or payment of deposit for the spent bag entered into the bag automate; a compartment (240) for storing the spent bags that has been entered through the opening (200), which compartment (240) has a second opening (250) through which the bag automate can be emptied for the spent bags.

In an embodiment the recycling automate and/or the bag automate has both a printer (220) and a card reader (230).

In an embodiment the recycling automate and/or the bag automate has a button for indicating that the spent items such as clothes and/or bags have been entered and a deposit receipt is to be printed or the deposit is to be transferred to a card by the card reader (230).

In another embodiment the opening (200) for entering items such as clothes and/or bags is above the second opening (250) for emptying the compartment (240).

In another embodiment the compartment (240) has a volume to hold at least 50 items such as clothes and/or bags, at least 100 items or at least 250 items.

In another embodiment a receiving unit (260), preferably a laundry or recycling bag is placed in the compartment (240), preferably by having its opening hung over a substantially circular ring (270).

In another embodiment the receiving unit (260) is a container adapted for being arranged inside said automate, so that the spent items that enters the automate, may be stored inside said container.

In an embodiment the receiving unit (260) is adapted to be removed from the automate through a second opening (250).

In an embodiment the second opening is at least larger than the first opening (200).

Hereby an easy and convenient way of emptying said automate is provided.

It is thus possible to empty the spent items from said automate in a plurality of ways. For example an entire container may be removed with all the spent items therein, and a new container can subsequently be placed therein. Alternatively the container is removed and emptied outside of the automate and then placed back inside said automate, preferably through the second opening (250).

Similarly a receiving unit such as a recycling bag may be position inside the automate for receiving and storing the spent items that enters the automate. Again this enables an easy and convenient way of emptying the automate. Furthermore, the use of a removable receiving unit and/or container also enables a more clean way of emptying said automate, ensuring that the person doing the emptying does not need to come into contact with the spent items, thereby minimising contamination and ensuring proper handling.

In another embodiment the bag and/or item identification (215) is a bar-code.

In another embodiment the bag and/or item identification (215) is a chip.

In another embodiment a bag automate (100) for receiving a chip-tagged bag (112) for reuse is provided, said bag automate comprising: a first opening (200) through which the bag can be entered; a reader (210) for registering the bag identification chip; a printer (220) for producing a deposit receipt and/or a card reader (230) for transfer of a token or payment of deposit for the spent bag entered into the bag automate; a compartment (240) for storing the spent bags that has been entered through the first opening (200), which compartment (240) has a second opening (250) through which the bag automate can be emptied for the spent bags.

In an embodiment the automate has access to a server through a private/public network for transfer of activity status and information obtained from the bag and/or item identification chip (215).

In an embodiment the spent item and/or bag (110) consists substantially of fabric, plastic, or a mixture thereof.

In another embodiment the spent item and/or bag (110) consists substantially of plastic.

In another embodiment the spent item and/or bag (110) consists substantially of cotton fabric, organic cotton fabric, bamboo fibres or organic bamboo fibres or a combination thereof.

In another embodiment the spent bag (110) consists substantially or mainly of compostable or biodegradable plastic, such as polylactic acid (PLA), polyhydroxyalkanoates (PHAs), starch blends (starch/polylactic acid, starch/polycaprolactone and starch/polybutylene-adipate-co-terephthalate), cellulose bioplastics (cellulose acetate-expensive), lignin-based polymer composites, polyglycolic acid (petroleum based), and polybutylene adipate terephthalate (PBAT).

In another aspect a chipped-tagged item and/or bag (112) for reuse is provided. The item/bag preferably has a volume of from about 2 liters to about 150 litters, and/or has a chip built into the bag/item, and/or has one or more handles (120) or shoulder straps for carrying the bag/item, and/or consists substantially of fabric, fibers, plastic or a mixture thereof.

In an embodiment the chip-tagged bag (112) consists substantially of cotton fabric, organic cotton fabric, bamboo fibres or organic bamboo fibres.

In an embodiment the chip-tagged bag (112) consists substantially or mainly of compostable or biodegradable plastic, such as polylactic acid (PLA), polyhydroxyalkanoates (PHAs), starch blends (starch/polylactic acid, starch/polycaprolactone and starch/polybutylene-adipate-co-terephthalate), cellulose bioplastics (cellulose acetate-expensive), lignin-based polymer composites, polyglycolic acid (petroleum based), and polybutylene adipate terephthalate (PBAT).

In another embodiment the chip-tagged item and/or bag (112) consists substantially or mainly of fabric made from natural products, e.g. hemp, flax, jute nettle and ramie.

In another embodiment the chip-tagged item and/or bag (112) has an in-use period of at least 50 times of recycling including washing, folding and packaging for re-use.

In another embodiment the chip-tagged item and/or bag has the chip placed inside the bag material so as not having any direct contact with the exterior of the bag, preferably the chip is placed inside the upper part in the perimeter (130) of the bag.

In another embodiment the chip solely serves to return the deposit from the chip-tagged bag to the individual or entity returning the bag and/or item.

In another embodiment the chip serves to return the deposit from the chip-tagged bag and/or item to the individual or entity returning the bag/item and serves to log information on the use of chip-tagged bag and/or item.

In another embodiment the present invention provides a kit of parts consisting of an automate as defined in the first aspect of the invention, and at least one, preferably a plurality of chip-tagged bags and/or items as defined in the embodiments of the invention.

The invention may be viewed as a bag automate permitting e.g. consumers to recycle a bag for the purpose of either being regenerated by e.g. washing prior to being sold for reuse.

The invention also may be viewed as a bag automate permitting e.g. consumers to return a plastic packaging bag for which there is a deposit and where the packaging bag is recycled as spent plastic.

The invention may be viewed as a recycling automate permitting e.g. consumers to recycle an item such as a piece of clothing for the purpose of either being regenerated by e.g. washing prior to being sold for reuse.

### BRIEF DESCRIPTION OF THE DRAWINGS

In the following, example embodiments are described according to the invention, wherein

FIG. 1 shows a bag automate (100) for receiving a spent bag (110).

FIG. 2 shows a ring (270) being placed inside the compartment (240) of the bag automate (100) for hanging a laundry or recycling bag (260) receiving the spent bags (110).

FIG. 3 illustrates a ring (270) for hanging the laundry or recycling bag (260) which is fitted onto a mount fitting into the compartment (240) of the bag automate (100).

FIG. 4 depicts a spent bag (110) having handles (120) and an upper part having a perimeter (130).

FIG. 5 depicts a chip-tagged bag (112) having handles (120), an upper part having a perimeter (130) wherein a bag identification (215) in the form of a chip is placed.

### DETAILED DESCRIPTION

In the following the invention is described in detail through embodiments hereof that should not be thought of as limiting to the scope of the invention.

It is to be understood, that even if the detailed description and figures present embodiments of the recycling automate with a as the spent item for reuse, the invention is not limited thereto. The item may just as well be a piece of fabric such as clothing.

In the context of this specification the words “used” and “spent” are used interchangeably. Likewise, the wording “item” is intended to cover both bags and/or clothes, but it may be used in an and/or combination with the wording “bag” as to preserve the priority subject-matter and text in an original form.

In the following description the wordings “bag” and “bag automate” and “bag identification” are used as examples. It will be readily understood, that this may understood as “item” and “item automate” or “recycling automate” and “item identification” to cover a piece of clothing or like item.

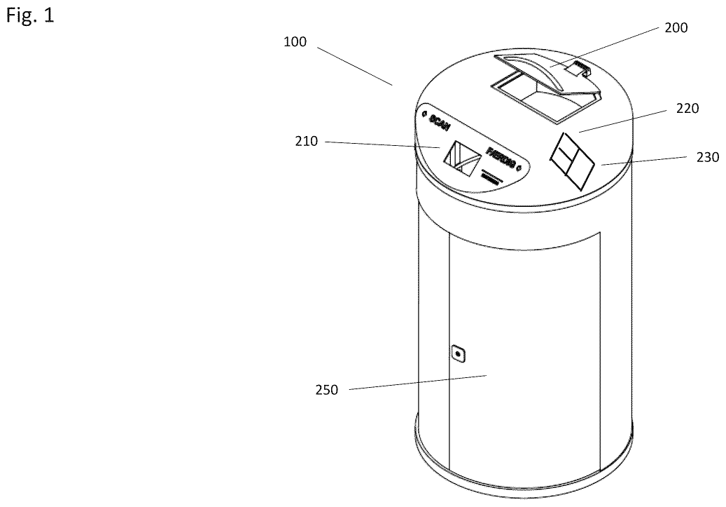

FIG. 1 conceptually illustrates a bag automate for receiving a chip-tagged bag for reuse. The spent bag is registered by placing the bag identification near the reader (210). Once the bag is registered it is entered via the first opening (200) such that it enters the compartment (240) for storing the spent bags that have been entered into the automate. In FIG. 1, the first opening (200) is illustrated as having a lid opening outwards. This is one option, but it is preferable that the first opening (200) has a lid opening downwards into the automate as this has functional advantages, e.g. the lid can be opened by pressing the spent bag towards the lid. In one embodiment the first opening (200) has a lid that opens downwards into the automate and which is hinged on one of the sides.

In the embodiment of FIG. 1 the bag automate has both a printer (220) for producing a deposit receipt and a card reader (230) for transfer of a token or payment of deposit for the spent bag. As one or more spent bags are entered, the printer can produce a receipt for the deposit against which the customer can receive the corresponding payment. Alternatively, the card reader (230) can transfer the deposit in the form of a payment or a token directly to the customers card (credit/payment card or a membership card).

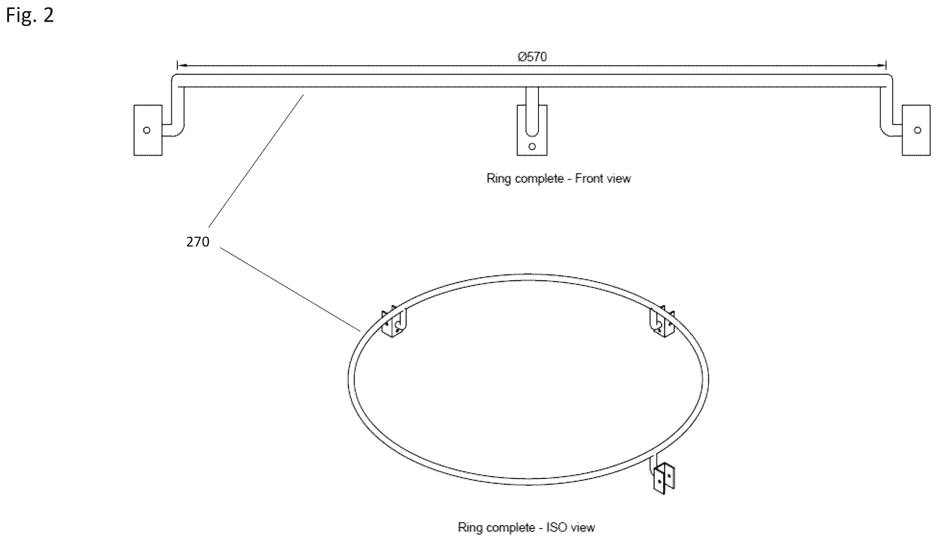

Once the bag automate has been in operation for a period of time, the compartment (240) for storing the spent bags is to be emptied via the second opening (250). Typically, this is done by removing a receiving unit (260) such as a laundry or recycling bag (260) which is placed in the bag automate. This laundry or recycling bag (260) may be hung on a ring in the automate such as to keep the laundry or recycling bag open for receiving the spent bags, c.f. FIG. 2.

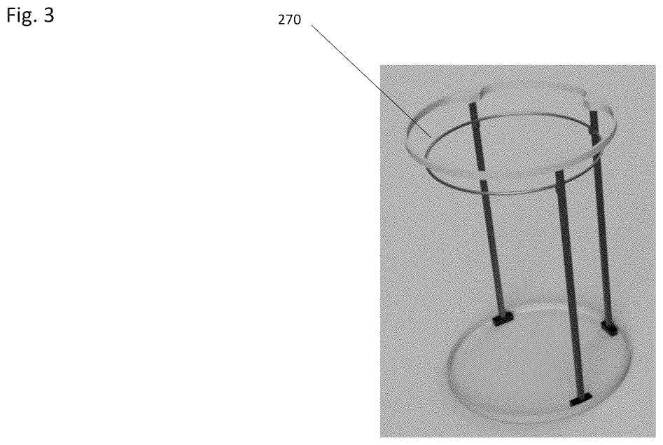

FIG. 3 illustrates the ring attached to a mount to be placed inside the compartment (240) of the bag automate. In some embodiments the compartment (240) has a volume to hold at least 50 spent bags, at least 100 spent bags, at least 150 spent bags, at least 200 spent bags or at least 250 spent bags. The spent bags (110) collected from the bag automate (100) may be regenerated for reuse by e.g. sorting and discarding worn-out bags, washing the bags followed by folding and packaging re re-distribution.

The bag identification (215) may be a bar-code or other visual code to identify the spent bag, in particular when the spent bag is a plastic packaging for single use followed by recycling of the material. For bags which are intended for repeated use, the bag identification (215) preferably is a chip placed inside or onto the bag. Such a chip-tagged bag (112) can deliver various information to the bag automate when registered and returned, such as the purchasing place and time, and the return place and time. The bag automate (100) may in some embodiments have access to a server through a private/public network for transfer of activity status and information obtained from the bag identification chip (215). This enables to calculate useful statistics on the use of the bags.

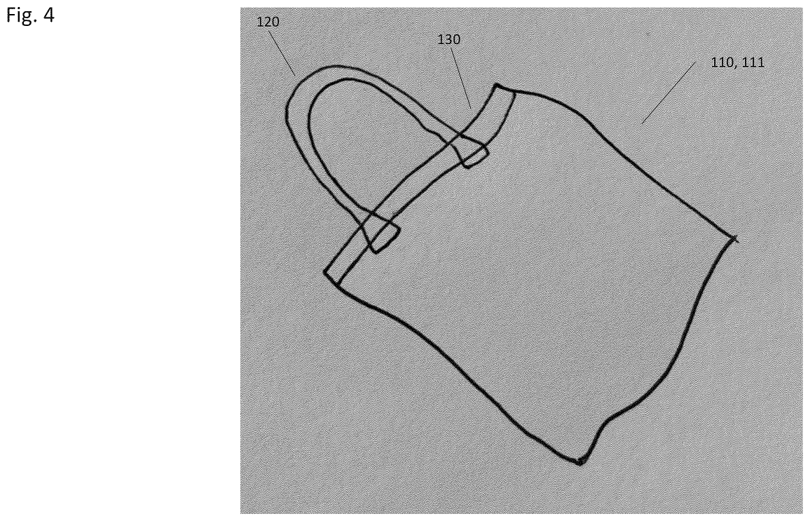

FIG. 4 illustrates a bag (110) or a spent bag (111) with a handle (120). The bag (110) and spent bag (112) may consist substantially of fabric, plastic or a mixture thereof. In some embodiments the bags consists substantially of cotton fabric, organic cotton fabric, bamboo fibres or organic bamboo fibres.

The present invention includes a chip-tagged bag (112) for reuse which has a volume of from about 2 liters to about 150 liters, which has a chip built into the bag, and which has one or more handles (120) or shoulder straps for carrying the bag, and which consists substantially of fabric, fibers, plastic or a mixture thereof.

In some embodiments, the chip-tagged bag (111) consists substantially of cotton fabric, such as organic cotton fabric.

In some embodiments the chip-tagged bag (112) consist substantially or mainly of compostable or biodegradable plastic, such as polylactic acid (PLA), polyhydroxyalkanoates (PHAs), starch blends (starch/polylactic acid, starch/polycaprolactone and starch/polybutylene-adipate-co-terephthalate), cellulose bioplastics (cellulose acetate-expensive), lignin-based polymer composites, polyglycolic acid (petroleum based), and polybutylene adipate terephthalate (PBAT).

In some embodiments the chip-tagged bag (112) consists substantially or mainly of fabric made from natural products, e.g. hemp, flax, jute nettle and ramie.

The chip-tagged bag (112) may have an in-use period of at least 20 times, at least 50 times or at least 100 times of recycling including washing, folding and packaging for re-use. The information conveyed via the chip may permit that the number of times that a chip-tagged bag is reused can be determined, so the chip-tagged bags having been reused above a threshold level can be identified and checked for either being suitable for further use or being ready for being discarded.

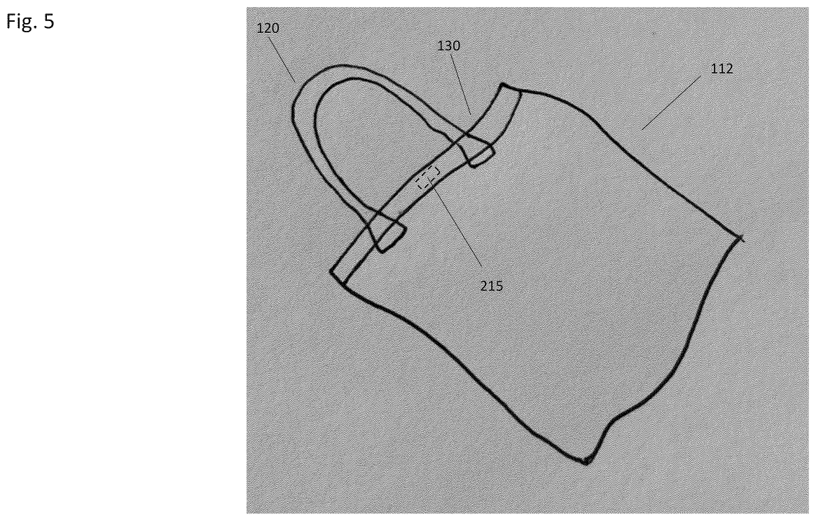

The chip-tagged bag may have the chip placed inside the bag material so as not having any direct contact with the exterior of the bag, preferably the chip is placed inside the upper part in the perimeter (130) of the bag, c.f. FIG. 5.

The chip may solely serve to return the deposit from the chip-tagged bag to the individual or entity returning the bag, but it may also serve to return the deposit from the chip-tagged bag to the individual or entity returning the bag as well as serve to log information on the use of the chip-tagged bag.

The bag automate (100) and the chip-tagged bag (112) of the present invention may be supplied as a combined kit of parts consisting of a bag automate (100) and a plurality of chip-tagged bags (112). In some embodiments, this kit of parts comprises a plurality of chip-tagged bags (112) in each of different sizes.

According to the present invention the following items are presented:
1. A bag automate (100) for receiving a spent bag (110), said bag automate comprising: an opening (200) through which the bag can be entered; a reader (210) for registering a bag identification (215); a printer (220) for producing a deposit receipt and/or a card reader (230) for transfer of a token or payment of deposit for the spent bag entered into the bag automate; a compartment (240) for storing the spent bags that has been entered through the opening (200), which compartment (240) has an opening (250) through which the bag automate can be emptied for the spent bags.
2. The bag automate according to item 1, which has both a printer (220) and a card reader (230).
3. The bag automate according to any of the preceding items, wherein the bag automate has a button for indicating that the spent bags have been entered and deposit receipt is to be printed or the deposit is to be transferred to a card by the card reader (230).
4. The bag automate according to any of the preceding items, wherein the opening (200) for entering bags is above the opening (250) for emptying the compartment (240).
5. The bag automate according to any of the preceding items, wherein a laundry or recycling bag (260) is placed in the compartment (240) by having its opening hung over a substantially circular ring (270).
6. The bag automate according to any of the preceding items, wherein the bag identification (215) is a bar-code.
7. The bag automate according to any of the preceding items, wherein the bag identification (215) is a chip.
8. A bag automate (100) for receiving a chip-tagged spent bag (112) for reuse, said bag automate comprising: an opening (200) through which the bag can be entered; a reader (210) for registering the bag identification chip (215); a printer (220) for producing a deposit receipt and/or a card reader (230) for transfer of a token or payment of deposit for the spent bag entered into the bag automate; a compartment (240) for storing the spent bags that has been entered through the opening (200), which compartment (240) has an opening (250) through which the bag automate can be emptied for the spent bags.
9. The bag automate according to item 8, which has access to a server through a private/public network for transfer of activity status and information obtained from the bag identification chip (215).
10. The bag automate according to any of the preceding items, wherein the spent bag (110) consists substantially of fabric, plastic or a mixture thereof.
11. The bag automate according to any of the preceding items, wherein the spent bag (110) consists substantially of cotton fabric, organic cotton fabric, bamboo fibres or organic bamboo fibres.
12. A chip-tagged bag (112) for reuse which has a volume of from about 2 litters to about 150 litters, which has a chip built into the bag, and which has one or more handles (120) or shoulder straps for carrying the bag, and which consists substantially of fabric, fibres, plastic or a mixture thereof.
13. The chip-tagged bag (112) according to item 12, which consists substantially of cotton fabric, organic cotton fabric, bamboo fibres or organic bamboo fibres.
14. The chip-tagged bag according to any of items 12-13, wherein the chip is placed inside the bag material so as not having any direct contact with the exterior of the bag, preferably the chip is placed inside the upper part in the perimeter (130) of the bag.
15. A kit of parts consisting of a bag automate as defined in any of items 1-11 and a plurality of chip-tagged bags as defined in any of items 12-14.

1. A recycling automate for receiving a used item such as a bag and/or a piece of clothing, said automate comprising:
a first opening through which the item may be positioned inside the automate,
a reader for registering an item identification,
a printer for producing a deposit receipt and/or a card reader for transfer of a token or payment of deposit for the used item placed inside the automate,
a compartment for receiving from the first opening the used item and/or storing said used item,
a second opening adapted to enable said automate to be emptied for used items.

2. The automate according to claim 1, which has both a printer and a card reader.

3. The automate according to claim 1, wherein the automate has a button for indicating that the spent bags and/or clothes have been entered and a deposit receipt is to be printed or the deposit is to be transferred to a card by the card reader.

4. The automate according to claim 1, wherein the first opening for entering bags and/or clothes is above the second opening for emptying the compartment.

5. The automate according to claim 1, wherein a receiving unit such as a laundry or recycling bag is placed in the compartment preferably by having its opening hung over a substantially circular ring.

6. The automate according to claim 5, wherein the receiving unit is adapted to store the spent items entered into the automate, and/or the receiving unit is adapted to be removed from the automate through the second opening.

7. The automate according to claim 1, wherein the item identification is a bar-code and/or is a chip.

8. The automate according to claim 7, wherein the spent item is a chip-tagged item such as a spent bag and/or spent piece of clothing for reuse, wherein said automate comprises: an opening through which the item can be entered; a reader for registering the item identification chip; a printer for producing a deposit receipt and/or a card reader for transfer of a token or payment of deposit for the spent item entered into the automate; a compartment for storing the spent items that has been entered through the first opening, which compartment has the second opening through which the automate can be emptied for the spent items.

9. The automate according to claim 7, which has access to a server through a private/public network for transfer of activity status and/or information obtained from the item identification chip.

10. The automate according to claim 1, wherein the spent item (110) consists substantially of fabric, plastic or a mixture thereof.

11. The bag automate according to claim 1, wherein the spent item consists substantially of cotton fabric, organic cotton fabric, bamboo fibres, organic bamboo fibres or a combination thereof.

12. A chip-tagged item for reuse preferably a bag having a volume of from about 2 liters to about 150 litters, and/or which has a chip built into the bag, and/or which has one or more handles or shoulder straps for carrying the bag, and/or which consists substantially of fabric, fibers, plastic or a mixture thereof.

13. The chip-tagged item according to claim 12, which consists substantially of cotton fabric, organic cotton fabric, bamboo fibres or organic bamboo fibres.

14. The chip-tagged item according to claim 12, wherein the chip is placed inside the item material so as not having any direct contact with the exterior of the item, preferably the chip is placed inside the upper part in the perimeter of the item.

15. An automate adapted for receiving a spent bag, said automate comprising: an opening through which the bag can be entered; a reader for registering a bag identification; a printer for producing a deposit receipt and/or a card reader for transfer of a token or payment of deposit for the spent bag entered into the bag automate; a compartment for storing the spent bags that has been entered through the opening, which compartment has an opening through which the bag automate can be emptied for the spent bags.

16. The automate according to claim 2, wherein the automate has a button for indicating that the spent bags and/or clothes have been entered and a deposit receipt is to be printed or the deposit is to be transferred to a card by the card reader.

17. The automate according to claim 16, wherein a receiving unit such as a laundry or recycling bag is placed in the compartment preferably by having its opening hung over a substantially circular ring.

18. The automate according to claim 17, wherein the item identification is a bar-code and/or is a chip.

19. The automate according to claim 18, wherein the spent item consists substantially of fabric, plastic or a mixture thereof.

20. The chip-tagged item according to claim 13, wherein the chip is placed inside the item material so as not having any direct contact with the exterior of the item, preferably the chip is placed inside the upper part in the perimeter of the item.
